(19) United States
(12) Patent Application Publication
(10) Pub. No.: US 2002/0051553 A1
(43) Pub. Date: May 2, 2002

(54) Microphone

(76) Inventors: Masahiko Moriguchi, Tottotri (JP); Tetsuro Inoue, Tottori (JP); Alexander Paritsky, Modiin (IL); Alexander Kots, Ashod (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/818,090

(22) Filed: Mar. 26, 2001

(30) Foreign Application Priority Data
Sep. 27, 1999 (JP) 11-271871

(51) Int. Cl. H04R 25/00; H04R 9/08

(52) U.S. Cl. 381/369; 381/171; 381/357

(57) ABSTRACT

Provided is a microphone with a stable output employing an aluminum membrane and having an air escape provided to the vibration detector. Specifically, the material used as the membrane frame material has a larger Young's modulus and a smaller thermal expansion coefficient than those of aluminum. Thereby, even if stress distribution or heat distribution is inflicted on the membrane frame, the slack or tension in the membrane will be reduced and the microphone output is stabilized.

### BACKGROUND OF THE INVENTION

1. Field of the Invention

The present invention relates to a microphone to be used as a small microphone in car phones and cellular phones, and for detecting intruders by utilizing the pressure change caused by an intruder.

2. Description of the Related Art

Typically, an aluminum membrane is used as the vibrating body of a microphone. This membrane is affixed to a membrane frame, which is provided with a ring-shaped or square hole, with an adhesive. The membrane is caused to vibrate by external sound, pressure change, etc., and this vibration is detected electrically or optically. Japanese Patent Application No. 10-107427 is an example of a microphone that optically detects vibrations. The membrane frame is made of aluminum, which is also used as the material for the membrane. Space between the membrane and vibration detector is set to approximately 25 micrometers in order to reduce air resistance. Further, an air escape is provided to the air detector in order to increase the membrane vibration amplitude. The air escape is positioned from the inner circle of the membrane frame to the inside of the microphone.

The aforementioned Japanese Patent Application No. 10-107427 has a problem that the microphone output would change due to change in ambient temperature or in humidity, or heat. Stress is inflicted on the membrane frame when the detector expands or contracts due to the change in ambient temperature or in humidity. The inflicted stress is not even, but rather distributed, due to the existence of the air escape. Similarly, the heat generated during the soldering process upon manufacturing microphones will not transmit evenly to the membrane frame due to the air escape, resulting in heat distribution. Such stress distribution and heat distribution will generate distortion in the membrane frame, and generate a slack or tension in the membrane, and the output of a microphone will vary.

### BRIEF SUMMARY OF THE INVENTION

According to the present invention, a material having a larger Young's modulus and a smaller thermal expansion coefficient than those of aluminum is used as the material for the membrane frame.

### DESCRIPTION OF THE SPECIFIC EMBODIMENTS

By using a material having a larger Young's modulus and a smaller thermal expansion coefficient than those of aluminum as the material for the membrane frame, the amount of distortion to the membrane frame will be small even if there is stress distribution or heat distribution in the membrane frame. As a result, the slack or tension in the membrane will also be reduced.

Steel has a Young's modulus of 20×10¹⁰ Pa and a thermal expansion coefficient of 11×10⁻⁶/° C., whereas aluminum has a Young's modulus of 7×10¹⁰ Pa and a thermal expansion coefficient of 23×10⁻⁶/° C. Thereby, if stress distribution or heat distribution is inflicted on the membrane frame, the amount of distortion is small when steel is used. The above is just one example, and other materials may be used so far as such materials satisfy the conditions of having a larger Young's modulus and a smaller thermal expansion coefficient than those of aluminum in order to decrease the amount of distortion and reduce the slack or tension caused to the membrane.

According to the present invention, the slack or tension on the membrane caused by change in ambient temperature or in humidity, or heat can be reduced, thereby stabilizing the microphone output.

What is claimed is:

1. A microphone employing an aluminum membrane and having an air escape provided to a vibration detector, wherein the material used as the membrane frame has a larger Young's modulus and a smaller thermal expansion coefficient than those of aluminum.
